(19) United States
(12) Patent Application Publication
(10) Pub. No.: US 2007/0139446 A1
(43) Pub. Date: Jun. 21, 2007

(54) SYSTEMS AND METHODS FOR MANIPULATING HIGH RESOLUTION SCAN IMAGES USING WEB-BASED USER INTERFACES

(75) Inventors: Ngaiman CHAU, Arcadia, CA (US); Chia-Hao LEE, Hacienda Heights, CA (US); John W. Wu, Rancho Palos Verdes, CA (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/275,149

(22) Filed: Dec. 15, 2005

(51) Int. Cl. G09G 5/00

(52) U.S. Cl. 345/660

(57) ABSTRACT

A system and method are provided by which a user, at a client workstation, can efficiently, simply and effectively manipulate, and specifically crop, a high resolution image that has been scanned and/or otherwise stored in a server with which the client worksation is in web-based communication. The disclosed system and method reduce and/or eliminate the need to transfer a file containing a full high resolution image from the server to the client workstation across a web-based data transfer network. A cropping request may be generated by a user via a client workstation and only that request may be transferred to, and implemented through, the server, eliminating significant data transfer requirements regarding the transfer of the extremely large files associated with high resolution images required of conventional cropping methods. An addition advantage is reduction and/or elimination of a need for sophisticated image display and processing software to reside within each client workstation.

### BACKGROUND

This disclosure is directed to systems and methods for providing a user a capability via a web-based user interface to manipulate high resolution images.

In distributed and/or networked information distribution or image producing systems, high resolution images, and manipulation of high resolution images, are dealt with in a number of different ways. High resolution images may be input to a server from image sources such as, for example, high resolution scanners. Once stored in a server, manipulation of a high resolution image to prepare it for display and/or other purposes, such as, for example, cropping of the high resolution image, may be undertaken via a variety of systems and methods. With growth in the use of web-based data communications to transfer files between servers, and between servers and individual client workstations, tasks are often shared between users directly manipulating software applications resident in the individual client workstations for accomplishing a number of tasks, or by users sending, via user interfaces on the client workstations and attached web-based data transfer networks, commands to the server for interaction with sophisticated software applications and other data, which may be resident within the server.

With regard to manipulation of high resolution images, a variety of systems and methods are conventionally used to perform such manipulation, and specifically cropping, of high resolution images on web-based client computer workstations, such as, for example, networked computer workstations.

### SUMMARY

Each of these systems and methods, however, suffers from one or more shortfalls. Many of the encountered shortfalls may be based on the size of the data file required to transfer a full high resolution image, or the shortfalls may be a result of the widely-varied and differing resolution capabilities of display units of individual client workstations as compared to the actual resolutions of the high resolution images.

In related art systems, full high resolution images are typically transferred via web-based data transfer networks from servers, in which the high resolution images have been stored, to one or more client workstations, very often as, for example, attachments to e-mails. File sizes for data representing full high resolution images stored in the server, and transferred to the client workstation via the web-based data transfer network, can be very large, representing specifically a large amount of binary data associated with a single high resolution image. The size of a file stored in a server, which is intended to be transferred via a web-based data transfer network connection as, for example, a data stream, representing a single 8½-inch×11-inch scanned high resolution image may be as large as 20 megabytes. A requirement to transfer such large data files will necessarily affect any system by which such transfer is effected. Handling of such large data files can prove very cumbersome, particularly when multiple images need to be transferred to multiple client workstations for further processing and/or manipulation.

In related art systems, manipulation, and specifically cropping, of high resolution images, once transferred to the client workstation, often occurs or is enabled by a user activating image processing software, which must be stored in, or otherwise accessible to, the client workstation. The large file containing the full high resolution image must be downloaded by the web-attached client workstation executing a program to display the full high resolution image, generally outside the installed web browser by which the client workstation received the data. This process itself often requires that sophisticated software applications be stored in the client workstation, and can be very time consuming itself based on the size of the image file. As indicated above, and as we will be discussed in greater detail below, an exemplary cropping process itself can be very cumbersome in that a full high resolution image may not be capable of being displayed on a single screen on a display unit of the client workstation based on the resolution capability of that display unit.

Once image manipulation is completed by a user applying the sophisticated software resident in the client workstation to the full high resolution image, a modified high resolution image may be output directly from the client workstation to an image sink connected to the client workstation. More typically, however, the modified high resolution image is transferred back over the web-based data transfer network to the server for further processing and/or output to one or more image sinks in direct communication with, the server. In this latter case, again the size of the data stream, or other data transfer mechanism, required to transfer the modified high resolution image back to the server is large, particularly when instructions regarding further processing of the modified high resolution image may be included as part of the file transfer.

As mentioned above, based on the resolution capacity of an image display unit on a web-attached client workstation, very often only a part of a received high resolution image, as decoded for display by the separate image processing software resident within the client workstation, can be displayed. In such instances, in order to manipulate the high resolution image, even after it has been transferred from the server and downloaded and/or opened by the image processing software application, a user must scroll the image horizontally and/or vertically, thereby complicating the drawing of, for example, any cropping indices, such as a cropping box, in order to indicate a portion of the high resolution image to be cropped.

Alternatively, in an effort to reduce at least this difficulty with the process, the image processing software may be usable to scale the high resolution image to fit the display as some automatically size-adjusted sub-sampled image. If such sub-sampled images are to be used for display, however, the image processing software must scale each received full high resolution image differently in order to fit the image into the display capability of the image display unit of the client workstation. Again here, some additional processing of the large transferred full high resolution image data file is required of an ever-more-sophisticated image processing software application resident within the client workstation.

Complex image processing software programs such as, for example, Java Applets® or Active® programs, for manipulating image data and particularly for, for example, drawing a cropping box and computing cropping coordinates, may be stored in each of the distributed web-attached client workstations to accomplish tasks as outlined above for related art systems. These image processing software programs, however, may not be compatible with certain web browsers, when a web-based networked approach to manipulating high resolution images is undertaken. Long loading times for complex image processing software applications to read and display, for example, the transferred full high resolution image, may also be a factor that impacts an individual user's ability, at a client workstation, to efficiently, correctly and effectively crop high resolution images.

It would be advantageous to provide a system and method by which a user, at a client workstation, could efficiently, simply and effectively manipulate, and specifically crop, a high resolution image that had been scanned, and/or otherwise stored, to a server with which the client workstation is in communication, such as, for example, web-based communication via a web-based data transfer network. An objective of such a system and method would be to reduce and/or eliminate the need to transfer a large file containing a full high resolution image from the server to the client workstation across the web-based data transfer network. In such instances, if, for example, a cropping request could be generated by a user via the client workstation and only that request transferred to, and implemented through, for example, the server connected via a web-based data transfer network, significant data transfer requirements, i.e., the transfer of extremely large files associated with full high resolution images required of conventional cropping methods, could be significantly reduced and/or eliminated. An additional advantage would be to reduce or eliminate the need for sophisticated image display and manipulation processing software to reside within each individual client workstation. Rather, it would be advantageous for the image processing software to be maintained only within the server.

In various exemplary embodiments, systems and methods according to this disclosure provide an algorithm to extract user information for an area to be cropped from a high resolution image, a simplified version of the full high resolution image being displayed directly on a web page, implemented, for example, in Java Script®, that could be supported by any and/or all web browsers. The algorithm may provide display of a scaled version of the high resolution image on a web page based on transfer of data indicative of the high resolution image, rather than the transfer of the full high resolution image file. A user may, via the web browser, associate cropping information by, for example, drawing a cropping box defining relative coordinates of a portion of an image to be cropped, with the scaled version of the high resolution image displayed on the web page. Relative coordinates regarding a modified version of the high resolution image may then be computed and transmitted as data from the web browser back to the server in which the high resolution image is stored. Alternatively, raw data regarding relative image coordinates may be transmitted to the server and all computations accomplished in the server. Sophisticated image processing software, maintained within the server, may then be enabled and provided with the user-desired inputs for cropping as computed relative coordinates to accomplish cropping of the high resolution image within the server in accordance with the individual user's desires.

In various exemplary embodiments, systems and methods according to this disclosure may use a <DIV> tag in Java Script to define an image canvas container with specified attributes as an image canvas area relative to a static origin, this area being easily accommodated within the window area of the web browser used by the client workstation. Within this defined image canvas container, a scaled version of a high resolution image, based on information indicative of the high resolution image transferred from the server, may be placed using, for example, an <IMG> tag in Java Script to set attributes associated with the displayed scaled version of the high resolution image on the web page. In this manner, the client workstation's web browser may automatically scale and display the image to fit in the image canvas container.

Next, a separate sub-container may be defined using, for example, a different <DIV> tag in Java Script. The size and the location of the sub-container may be determined by manipulation of, for example, a user interface by which a user at the client workstation can define the sub-container to be a sub-area of an image, such as, for example, a cropped image area of the high resolution image. A typical example of such a user interface at a client workstation is a computer mouse, with the capability of the client workstation to receive user inputs via interpretation of, for example, mouse down, drag and mouse up events (also alternatively referred to as “click and drag ” events). In exemplary embodiments according to the systems and methods of this disclosure, a border of the defined sub-container may be displayed as, for example, a cropping box or other visual indicia of an area in the high resolution image to be cropped or otherwise manipulated, as drawn by the user. Relative positions of this sub-container with respect to the overall image canvas container may be computed in order to generate data regarding a relative window. Raw or computed data regarding this relative window may be transmitted to the server in order that the image processing software resident in the server can accomplish the user-requested manipulation, e.g., cropping, of the stored high resolution image in the server.

Various exemplary embodiments of the systems and methods according to this disclosure are usable to implement manipulation, and specifically cropping, of high resolution images using web-based user interfaces such as, for example, individual client workstations. In exemplary embodiments of disclosed systems and methods, manipulation and/or cropping of high resolution images is undertaken without any necessity to transfer an entire large data file representing data regarding the full high resolution image from the server in which such a data file is stored to one or more distributed client workstations. Also, a requirement for sophisticated image processing software to be resident within each client workstation, so that the high resolution image can be displayed and manipulated, e.g., cropped, is reduced and/or eliminated.

In exemplary embodiments, manipulated and/or cropped high resolution images may be transferred to a client workstation for display or other processing, or preferably modified high resolution images may be downloaded directly from the server to one or more image sinks.

These and other features and advantages of the disclosed embodiments are described in, or apparent from, the following detailed description of various exemplary embodiments.

### BRIEF DESCRIPTION OF THE DRAWINGS

Various exemplary embodiments of disclosed systems and methods will be described, in detail, with reference to the following figures, wherein:

FIG. 1 illustrates a block diagram of an exemplary system for manipulating high resolution images using web-based user interfaces;

FIG. 2 illustrates an alternative exemplary embodiment of a client workstation usable as a web-based user interface; and

FIG. 3 is a flowchart outlining an exemplary method for implementing manipulating, and specifically cropping, of high resolution images using web-based user interfaces.

### DETAILED DESCRIPTION OF EMBODIMENTS

The following description of various exemplary embodiments of systems and methods for implementing cropping of high resolution images may alternatively refer to high resolution images that have been scanned, and/or information regarding the high resolution images that is transferred from a central server to client workstations via a network such that information regarding cropping of the images may be transferred to the server via web-based user interfaces. However, it should be appreciated that the disclosed principles may find equal application in other high resolution image manipulation settings, such as, for example, embedding a dialog box in a high resolution image.

Image sources and image sinks, as depicted, outlined and/or discussed below, may include, but are not limited to copiers, printers, scanners, facsimile machines, multi-function devices for production and/or reproduction of images, and xerographic image forming devices.

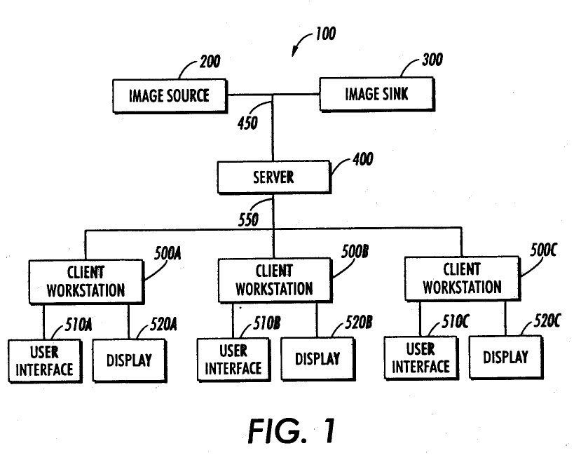

FIG. 1 illustrates a block diagram of an exemplary system 100 for manipulating high resolution images using web-based user interfaces. As shown in FIG. 1, the exemplary system 100 may include an image source 200, an image sink 300, a server 400, and at least one client workstation 500 (shown in exemplary manner as a plurality of client workstations 500A-C). The image source 200 and image sink 300 may be connected to the server 400 via a data/control bus 450. Each of the plurality of client workstations 500A-C may further include at least a user interface 510 and a display unit 520, as well as incorporating a memory unit (not shown) and a controller (not shown) within the client workstation 500. The plurality of client workstations 500A-C may be connected to the server by a web-based or other data transfer network 550.

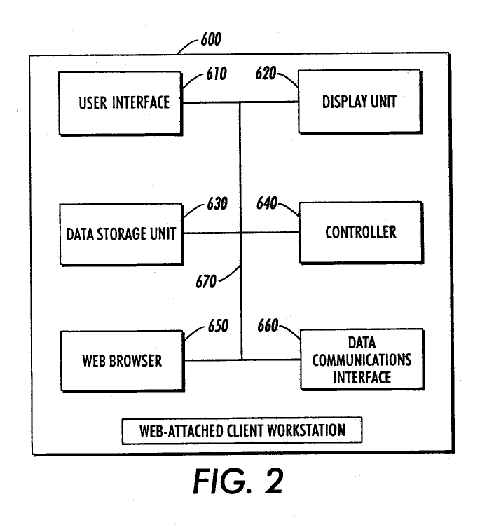

FIG. 2 illustrates an exemplary embodiment of a client workstation 600 usable as a web-based user interface. As shown in FIG. 2, the client workstation 600 may include a user interface 610, a display unit 620, a data storage unit 630, a controller 640, a web browser 650 and a data communications interface 660, all connected via a data/control bus 670.

Returning to FIG. 1, in various exemplary embodiments, the image source 200 may be or include any form of image receiving, image producing/reproducing and/or image forming device such as, for example, an image scanning device, an image digital data storage device, a digital still or video camera, and/or a locally or remotely located computer and/or data manipulation workstation, in addition to the list of exemplary systems discussed in paragraph [0023] above. The image source 200 may be integrated with, or connected remotely to, either or both of the image sink 300 and the server 400. The image source 200, if a device or unit that is separate from the server 400, may be connected to the server 400, for example, by either a direct or network data communication link, including any one or more of a wired, wireless and/or optical link.

In various exemplary embodiments, the image sink 300 may be or include, for example, a hard-copy document production device such as, for example, one or more of those listed in paragraph [0023] above. It should be appreciated, however, that this disclosure is not limited to such applications. In general, the image sink 300 may be any device that is capable of outputting a full or modified high resolution image generated by the server 400, such as, for example, a printed image, a copied image, or any other hard-copy output image, an image on a digital display device, image data exportable to a transportable memory device or digital data storage medium, and/or any other image data storage and/or display capability.

The image source 200 may be usable to provide a high resolution image input to the server 400. The server 400 may include a capability to store an input high resolution image received from, for example, the image source 200. Additionally, any image processing software, be it simple or sophisticated, may also be resident within the server 400.

As will be described in detail below, a user at a client workstation 500 may view a scaled version of an input high resolution image stored in the server 400 by, for example, requesting information indicative of the stored high resolution image via a web browser or other device installed in the client workstation 500. Such a request may be input via an exemplary user interface 510 associated with the client workstation 500. The received data indicative of the requested high resolution image may be displayed as a scaled version of the high resolution image on a web page displayed on the display unit 520 of the client workstation 500.

In response to the user query via the client workstation 500 and the associated systems, a request may be sent via a web-based data transfer network 550 to the server 400, which in turn provides data indicative of the high resolution image back to the client workstation 500 for display as a scaled version of the high resolution image for user manipulation, e.g., cropping, of the image.

Employing exemplary disclosed systems and methods, a user, via a user interface 510 of a client workstation 500, may input data indicative of the desired manipulation, and specifically cropping, of the high resolution image. This data may be viewable on the display device 520 associated with the client workstation 510 as, for example, a cropping box around the intended cropped area, and/or other visual indicia of the area to be cropped or otherwise manipulated.

It should be appreciated that all of the displayed data regarding either the high resolution image, and/or the cropping indicators, displayed on the exemplary display device 520 of the client workstation 500 represents simply data indicative of the high resolution image and the cropping indicators and not the actual high resolution image and/or the actual cropping parameters.

Based on knowing an absolute position regarding the displayed scaled version of the high resolution image, the web browser with which the client workstation 500 effects web or other network communication, in simple format, such as, for example, Java Script format, determines relative positions, with respect to the entire displayed version of the high resolution image, of the cropping indicators. This data may be processed in the client workstation 500 and transmitted back to the server 400, or alternatively transmitted as raw data to the server 400 for further processing in the server 400. In the server 400, image processing software receives, and optionally processes, the data regarding relative positions of the cropping indicators, and applies that data to the data associated with the actual high resolution image stored in the server 400. In the server 400, the actual cropping or other manipulation of the high resolution image, undertaken via stored image processing software, is accomplished.

An exemplary cropped image, cropped in accordance with data input by the user at the client workstation 500, may then be transmitted back to the client workstation 500 from the server 400 for actual display on the display unit 520 of the client workstation 500 or for other processing, or may be output directly to an image sink 300 connected to the server 400.

It should be appreciated that, given the required inputs, software algorithms, hardware/firmware circuits, and/or any combination of software and hardware/firmware control elements may be used to implement individual devices, and/or units, in the exemplary system 100.

It should be appreciated that although depicted as individual devices in FIG. 1, the image source 200 and the image sink 300 may be combined. The image source 200 and the image sink 300 may be individually, or as a combined unit, attached to the server 400 by any data communication path that facilitates communication and coordination with the server 400 such as, for example, one or more of wired, wireless, and/or optical connections. These elements may alternatively be internal to a single unit comprising the server 400, the image source 200 and the image sink 300.

Any data storage unit described above such as, for example, those described as being internal to either the server 400 or a client workstation 500/600, may be implemented by any appropriate combination of alterable, volatile or non-volitle memory, or non-alterable, or fixed, memory. The alterable memory, whether volatile or non-volatile, may be implemented using any one or more of static or dynamic RAM, a computer disk and compatible disk drive, a writeable or a re-writeable optical disk and associated disk drive, a hard drive, a flash memory, a hardware circuit, a firmware circuit, or any other like memory medium and/or device. Similarly, the non-alterable, or fixed, memory may be implemented using any one or more of ROM, PROM, EPROM, EEPROM, and optical ROM disk, such as a CD-ROM or DVD-ROM disk with a compatible disk drive, or any other like memory storage medium and/or device.

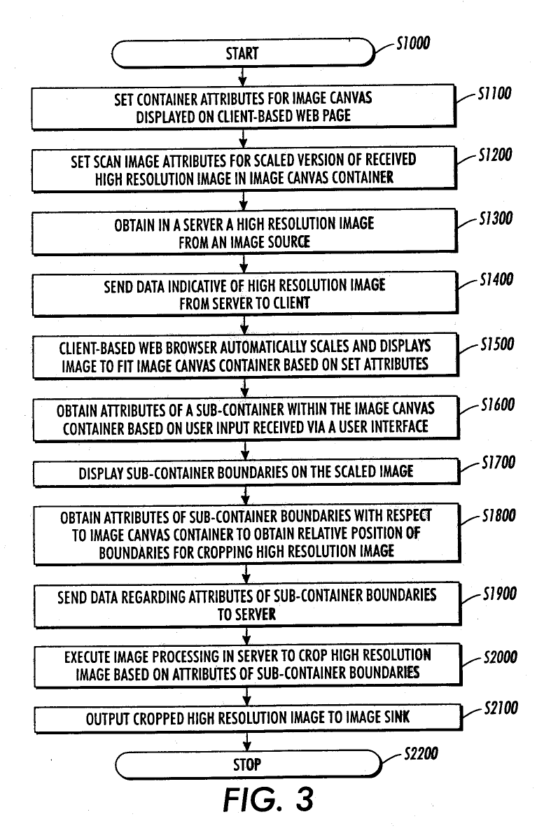

FIG. 3 is a flowchart outlining an exemplary method for implementing manipulating, and specifically cropping, of high resolution images using web-based user interfaces. As shown in FIG. 3, operation of the method begins at step S1000 and continues to step S1100 where attributes may be set for a sample image area on, for example, a web page. These attributes may be referred to, for example, as an “image canvas container ” upon which scaled representations of input image data indicative of a high resolution image to be manipulated may be presented. Exemplary embodiments of disclosed systems and methods may employ, for example, Java Script instructions, supported by virtually all web browsers, to set and/or define the attributes of this image canvas container. An exemplary Java Script instruction may be, for example, defined as a <DIV> tag with attributes of style =“position: relative” and width=60%. In this manner, an image canvas container can be created with an area equivalent to 60 percent of the web browser window area. Such instruction may appear, for example, as follows:
<DIV ID=“ImageCanvas” style=“position:relative; width:60%; cursor:crosshair”>
Operation of the method continues to step S1200.

In step S1200, scan image attributes may be set. Again, here, these attributes may be, for example, set in Java Script format as compatible to the browser employed by the client workstation. Within the image canvas container, image data indicative of the high resolution image stored in the server may be placed using, for example, an appropriate <IMG> tag. In this manner, a client workstation's web browser, for example, may automatically scale and display the image to fit into the image canvas container area with full width visibility. Such a Java Script instruction may appear as follows:
<IMG name=“ScanImage″ src=”./images/scan70.JPG“ width=100%”>
Operation of the method continues to step S1300.

Instep S1300, a high resolution image may be obtained from an image source by the server. The high resolution image may be stored as a data file in the server or the data may be otherwise temporarily held by the server only for the duration of a cropping event. Operation of the method continues to step S1400.

In step S1400, data indicative of a high resolution image that has previously been obtained by, and optionally stored in, the server may be transmitted to a client by, for example, web-based communication between a client workstation and the server. This data does not represent the entire data stream related to the full high resolution image, but rather data indicative of the full high resolution image as may be used to display a scaled version of the high resolution image on a web page. Data indicative of the high resolution scanned image may be transmitted, for example, across a web-based data transfer network connection to the client workstation.

Operation of the method continues to step S1500.

In step S1500, a client workstation-based web browser may automatically receive, scale and display the data indicative of the high resolution image on a web page based on the attributes for such display established in previous steps. Operation of the method continues to step S1600.

In step S1600, attributes may be set for a sub-container relative to the image canvas container where the data indicative of the high resolution image was placed in accordance with the above specified attributes. An example of a Java Script instruction as a second <DIV> tag for this step may be as follows:
<DIV ID=“rect” style=“position:absolute”></DIV>
In this manner, and applying the above-listed exemplary attributes, written in Java Script format, the size and location of the sub-container may be determined by interpretation of a user input via a user interface. Typically, such user input may be provided via, for example, a mouse and interpretation of mouse down, drag and mouse up (“click and drag”) events. Operation of the method continues to step S1700.

In step S1700, the user-input events may be visually presented with a border of the sub-container being displayed as generated as, for example, a cropping box drawn by the user, or other visual indicia of the area of the scaled version of the high resolution image to be cropped. Operation of the method continues to step S1800.

In step S1800, the attributes of the sub-container with respect to the image canvas container may be processed to obtain a relative position of the cropping box in the displayed scaled version of the high resolution image presented on the web page of the web browser. A relative position of this sub-container with respect to the image canvas container may be computed to generate data to be transferred to the server regarding user's desired cropping inputs or alternatively raw data regarding such user's desired cropping inputs may be transferred. Operation of the method continues to step S1900.

In step S1900, data regarding the processed or raw attributes of the sub-container boundaries are communicated to the server. Operation of the method continues to step S2000.

In step S2000, the server receives the relative position data and employs this data, via image processing software, to crop the high resolution image. As such, the server may execute at least one of an image processing application, operation, routine, or sub-routine and the high resolution image may be cropped based on the processed attributes of the sub-container that are transferred to the server. Operation of the method continues to optional step S2100, or directly to step S2200 where the operation of the method stops.

In optional step S2100, a modified high resolution image is output to an image sink.

It should be appreciated that while described in exemplary manner in the above-detailed method as employing Java Script instructions via a web browser to implement the exemplary simple cropping algorithm to provide cropping information back to a server via a web-based data transfer network in order that a high resolution image stored in the server can be cropped using image processing software resident in the server, the systems and methods according to this disclosure are not so narrowly limited as to be applicable only to a system or method including and/or incorporating each of these steps and/or features. Various combinations of the steps and/or features are possible.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for manipulating high resolution images, comprising:
setting attributes of an image area on a web page to be displayed on a client workstation;
setting attributes for displaying a scaled version of a high resolution image in the image area of the web page;
communicating data indicative of a high resolution image to the client workstation;
displaying a scaled version of the high resolution image based on the data indicative of the high resolution image in the image area on the web page on a display device of the client workstation;
receiving input from the client workstation regarding user-desired manipulation of the high resolution image as attributes of a sub-container relative to the displayed image area on the web page; and
manipulating the high resolution image in the server based on the received input regarding the attributes of the sub-container.

2. The method of claim 1, wherein setting attributes occurs using Java Script instructions.

3. The method of claim 1, wherein at least one of communicating data or receiving input occurs across a web-based data transfer network.

4. The method of claim 1, wherein displaying the scaled version of the high resolution image further comprises enabling a web browser used by the client workstation to display the scaled version of the high resolution image directly on the web page displayed on the display device of the client workstation.

5. The method of claim 1, wherein receiving input from the client workstation regarding user-desired manipulation of the high resolution image further comprises receiving inputs via a user interface device in communication with the client workstation.

6. The method of claim 5, wherein the user interface is a computer mouse.

7. The method of claim 1, wherein manipulating the high resolution image comprises cropping the high resolution image, and boundaries of the sub-container are displayed with the information indicative of the high resolution image on the display device of the client workstation.

8. The method of claim 1, wherein manipulating the high resolution image comprises executing at least one of an image processing application, operation, routine, or sub-routine in the server to crop the high resolution image.

9. The method of claim 1, further comprising outputting a manipulated high resolution image to an image sink.

10. The method of claim 9, wherein at least one of the image source or the image sink comprises an image forming device including the method of claim 1.

11. The method of claim 9, wherein at least one of the image source and the image sink is a xerographic image reproducing device.

12. The method of claim 1, wherein the image source is an image scanning device.

13. A digital data storage medium on which is stored a program for implementing the method of claim 1.

14. A system for manipulating high resolution images, comprising:
an image server usable to manipulate an input high resolution image;
an image source for inputting a high resolution image to a server; and
at least one client workstation in communication with the server, the at least one client server usable to at least receive user inputs regarding manipulating the high resolution image,
wherein attributes regarding an image area on a web page to be displayed on the client workstation, and attributes for displaying a scaled version of the high resolution image on the web page are set for a web browser used by the client workstation,
information indicative of the high resolution image is communicated from the server to the client workstation, the information comprising data other than a data file containing the full high resolution image,
the information indicative of the high resolution image is displayed on a display device of the client workstation directly on a web page in the image area according to the set attributes,
the server receives user-desired inputs regarding manipulation of the high resolution images represented as a sub-container within the image area, attributes of the sub-container being processed with respect to the image area in the server, and
manipulating the high resolution image is executed in the server based on the data regarding the processed attributes of the sub-container.

15. The system of claim 14, wherein setting attributes occurs using Java Script instructions.

16. The system of claim 14, wherein input regarding user-desired manipulation of the high resolution image comprises receiving user-desired inputs via a user interface device in communication with the client workstation.

17. The system of claim 14, wherein manipulating the high resolution image in the server comprises executing at least one of an image processing application, operation, routine, or sub-routine in the server to crop the high resolution image.

18. The system of claim 14, further comprising an image sink for receiving a manipulated high resolution image output from the server.

19. The system of claim 18, wherein an image forming device comprises at least one of the image source or the image sink.

20. The system of claim 19, wherein the image forming device comprises a xerographic image producing device.
